(19) United States
(12) Patent Application Publication
(10) Pub. No.: US 2004/0008368 A1
(43) Pub. Date: Jan. 15, 2004

(54) Mailing online operation flow

(76) Inventors: Michael K Plunkett, Fairfax, VA (US); Jeffrey J Tackes, Washington, DC (US); Lee B Garvey, Arlington, VA (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/362,283

(22) PCT Filed: Sep. 7, 2001
(86) PCT No.: PCT/US01/27684

(51) Int. Cl. B41J 1/00; B41B 1/00; B41F 1/00; G06K 1/00; G06F 15/00

(52) U.S. Cl. 358/1.15

(57) ABSTRACT

A method and system are provided for delivery of a printed document using at least one processor (1030) interfacing a network (1020). The processor (1030) may receive first information, through the network 81020) specifying an electronic version of a document. Then the processor (1030) may provide second information indicating one or more options for printing the document, and a customer may select a printing option. The processor (1030) may receive third information indicating at least one physical delivery address for sending the document, process the document accordint to the selected printing option to create a print file, select a printing site (1040). The print file may be printed at the selected printing site (1040) and provided to a service provider (1050) for transport to a delivery address.

### CROSS REFERENCE TO RELATED APPLICATIONS

This application claims the benefit of U.S. Provisional Patent Application No. 60/230,787, entitled “MAILING ONLINE OPERATION FLOW” and filed on Sep. 7, 2000, the disclosure of which is expressly incorporated herein by reference in its entirety.

### DESCRIPTION OF THE INVENTION

1. Field of the Invention

The present invention relates to systems and methods for automated production, transmission, and delivery of documents.

2. Background of the Invention

Traditionally, customers generate mailings by producing documents in physical form for sending the physical documents to a service provider (SP), such as the United States Postal Service (USPS™), Federal Express (FEDEX™), or United Parcel Service (UPS™). The SP must sort each physical document by delivery address, transport each physical document to a SP hub located near the delivery address, and deliver each document to the designated delivery address.

The traditional scheme for producing and sending documents is inconvenient and inefficient for small volume or short-run mailings. For example, consider a customer who needs to print and send a few thousand brochures. Initially, the customer may contract with a printer to print, fold and staple each brochure. Then the printer prepares sample brochures, which the customer reviews before beginning a production run. Typically, a customer may inspect several samples to determine whether the printer provides an acceptable quality of service before authorizing the printer to begin production.

Next, the customer addresses each brochure with a delivery address of an intended recipient selected from an address list. Each brochure usually must be addressed according to a specific predetermined format. For example, when the USPS™ is selected as the SP, a format specified by postal regulations is required to qualify for discounted service rates. The customer can create and maintain his own mailing list. However, maintaining a list of several thousand addresses in the required format for discounted service rates may be inconvenient and inefficient for many customers. The customer may also find that addressing a few thousand brochures that have been folded and stapled requires significant manual effort. After the brochures have been addressed, the customer transports the brochures to the SP.

Finally, the SP accepts the brochures from the customer. First, the SP must examine each brochure to determine the intended recipient. Second, the SP routes each brochure to a SP distribution site located near the delivery address. Third, each brochure must be delivered to the intended recipient. Each brochure that is sent must be handled several times before delivery to the intended recipient. Thus, a significant fraction of the cost to produce and send a document may be attributed to physically transporting the document from place to place.

Traditional electronic mailing services, such as e-mail, offer a lower-cost alternative for distribution of documents, when the customer has an appropriate address for routing documents to the intended recipient. However, business mailings are often targeted to recipients based on their geographic location. The customer may be unable to determine an appropriate e-mail address corresponding to each street address. Also, many potential mail recipients do not have e-mail addresses. Consequently, traditional electronic mailing services do not provide an effective alternative to the traditional mailing scheme.

It is therefore desirable to facilitate generating and sending documents by customers through increased use of automation. This may be achieved by eliminating manual processing stages, which reduces inconvenience and aggregate cost of producing a small volume or short-run mailing.

### SUMMARY OF THE INVENTION

A method consistent with an aspect of the present invention may provide for delivery of a printed document using at least one processor interfacing a network, the method comprising: receiving first information, through the network and at the at least one processor, specifying an electronic version of a document; providing second information, from the at least one processor and through the network, indicating one or more options for printing the document; selecting a printing option from the one or more options for printing the document; receiving third information, through the network and at the at least one processor, indicating at least one physical delivery address to which the document will be sent; processing the electronic version of the document according to the selected printing option to create a print file; selecting a printing site from one or more printing sites; transmitting the print file to the selected printing site; printing the print file at the selected printing site; and providing the printed document to a service provider for delivery to the physical delivery address.

A system consistent with another aspect of the present invention may provide for delivery of a printed document, using at least one processor interfacing a network, the system comprising: means for receiving first information, through the network and at the at least one processor, specifying an electronic version of a document; means for providing second information, from the at least one processor and through the network, indicating one or more options for printing the document; means for selecting a printing option from the one or more options for printing the document; means for receiving third information, through the network and at the at least one processor, indicating at least one physical delivery address to which the document will be sent; means for processing the electronic version of the document according to the selected printing option to create a print file; means for selecting a printing site from one or more printing sites; means for transmitting the print file to the selected printing site; means for printing the print file at the selected printing site; and means for providing the printed document to a service provider for delivery to the physical delivery address.

A computer program product, consistent with yet another aspect of the present invention, comprising a computer readable medium having computer program code embodied in said medium, may provide for delivery of a printed document using at least one processor interfacing a network, wherein the program code comprises: code for receiving first information, through the network and at the at least one processor, specifying an electronic version of a document; code for providing second information, from the at least one processor and through the network, indicating one or more options for printing the document; code for selecting a printing option from the one or more options for printing the document; code for receiving third information, through the network and at the at least one processor, indicating at least one physical delivery address to which the document will be sent; code for processing the electronic version of the document according to the selected printing option to create a print file; code for selecting a printing site from one or more printing sites; code for transmitting the print file to the selected printing site; code for printing the print file at the selected printing site; and code for providing the printed document to a service provider for delivery to a physical delivery address.

A method consistent with still another aspect of the present invention may provide for on-line document printing and mailing service comprising: receiving a recipient address data list for an electronic document; receiving sender selected document printing and finishing specifications from a predetermined specification list; processing the electronic version of the document and coordinating the electronically processed version of the document with the recipient address data list to create an electronic print file; transmitting the electronic print file to a document print site selected on the basis of the recipient mailing address code; printing the document and a mailing permit therefore; and transporting the document and mailing permit to a local mail service provider based on the recipient mailing address code, whereby the local mail service provider accepts, processes and delivers the document to the recipient.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as described. Further features and/or variations may be provided in addition to those set forth herein. For example, the present invention may be directed to various combinations and subcombinations of the disclosed features and/or combinations and subcombinations of several further features disclosed in the following detailed description.

### BRIEF DESCRIPTION OF THE DRAWINGS

FIG. 1 is a block diagram of an exemplary model for communication between a customer and a service provider in which methods and systems consistent with the present invention may be implemented;

FIGS. 2A and 2B are flow charts of an exemplary technique for sending a document from the customer to an addressee;

FIG. 3 is an exemplary graphical user interface for a mailing online service in accordance with methods and systems consistent with the present invention;

FIG. 4 is an exemplary graphical user interface for registering a new customer in accordance with methods and systems consistent with the present invention;

FIGS. 5A and 5B are an exemplary graphical user interface for profiling a new customer in accordance with methods and systems consistent with the present invention;

FIG. 6 is an exemplary graphical user interface for accessing a mailing online service in accordance with methods and systems consistent with the present invention;

FIG. 7 is an exemplary graphical user interface for ordering a mailing online service in accordance with methods and systems consistent with the present invention;

FIG. 8 is an exemplary graphical user interface for selecting a document to be sent in accordance with methods and systems consistent with the present invention;

FIG. 9 is an exemplary graphical user interface for maintaining one or more mailing lists in accordance with methods and systems consistent with the present invention;

FIG. 10 is an exemplary graphical user interface for adding a new address to an address book in accordance with methods and systems consistent with the present invention;

FIG. 11 is an exemplary graphical user interface for selecting one or more addresses from an online address book in accordance with methods and systems consistent with the present invention;

FIG. 12 is an exemplary graphical user interface for adding a new address group in accordance with methods and systems consistent with the present invention;

FIG. 13 is an exemplary graphical user interface for customizing an address field in accordance with methods and systems consistent with the present invention;

FIG. 14 is an exemplary graphical user interface for requesting a sample document in accordance with methods and systems consistent with the present invention;

FIG. 15 is an exemplary graphical user interface for monitoring status of a pending service order in accordance with methods and systems consistent with the present invention;

FIG. 16 is an exemplary graphical user interface for reviewing one ore more completed service orders in accordance with methods and systems consistent with the present invention;

FIG. 17 is an exemplary graphical user interface for updating customer registration information in accordance with methods and systems consistent with the present invention.

### DESCRIPTION OF THE EMBODIMENTS

Reference will now be made in detail to the present exemplary embodiments of the invention, examples of which are illustrated in the accompanying drawings. Wherever possible, the same reference numbers will be used throughout the drawings to refer to the same or like parts.

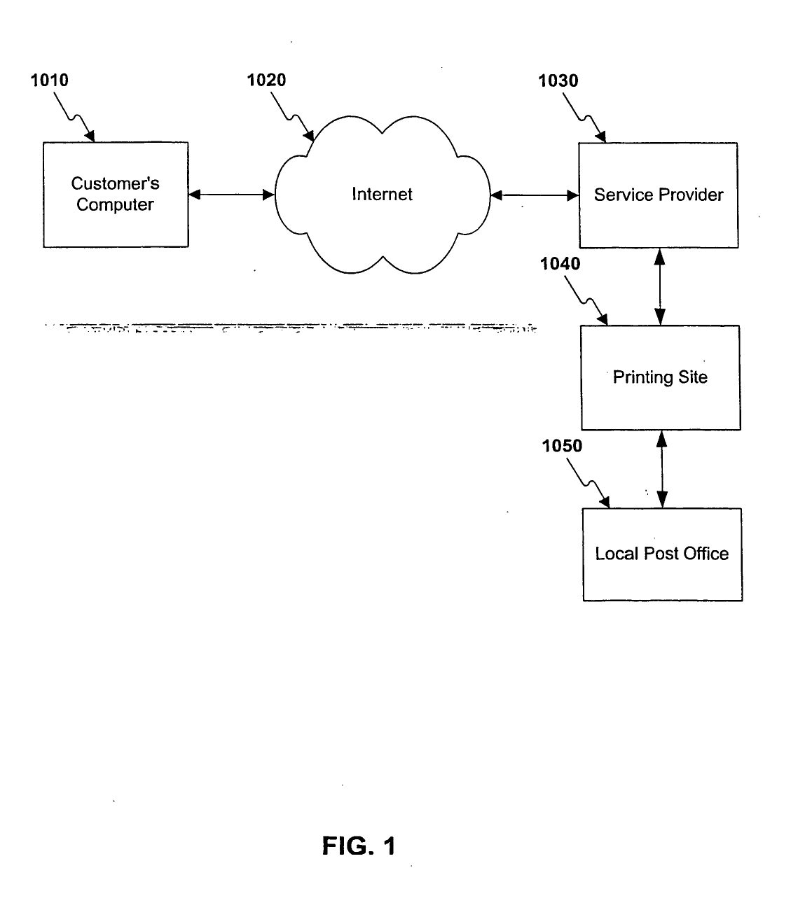

FIG. 1 shows a general block diagram of a customer and service provider communication model in which methods and systems consistent with the present invention may be implemented. Although the system set forth herein is described with respect to the USPS™, the system and methods described are not limited to the USPS™ but may be used with other service providers (SP). A customer may use a processor 1010, such as a personal computer, to transmit a document to a service provider 1030 through a network 1020, such as the Internet. SP 1030 may distribute the document to a printing site 1040. Then the printing site 1040 may print the document and provide the printed document to a letter carrier 1050, such as a local post office, to physically transport the printed document to a physical delivery address.

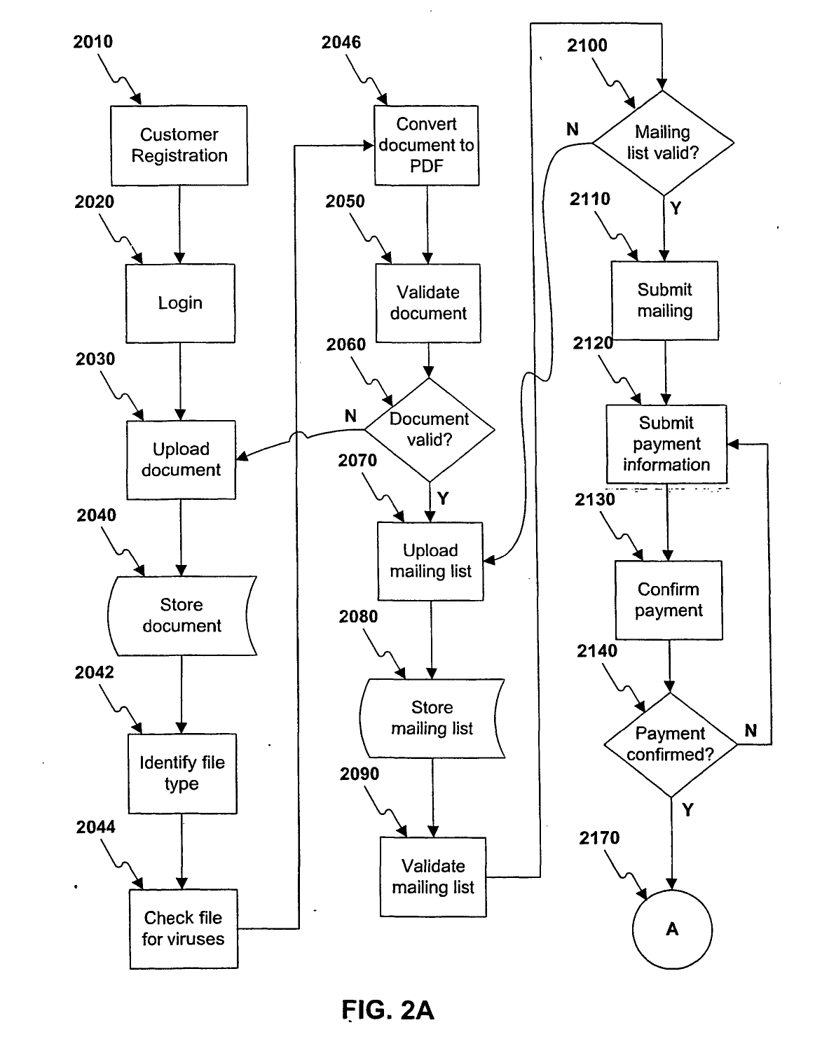

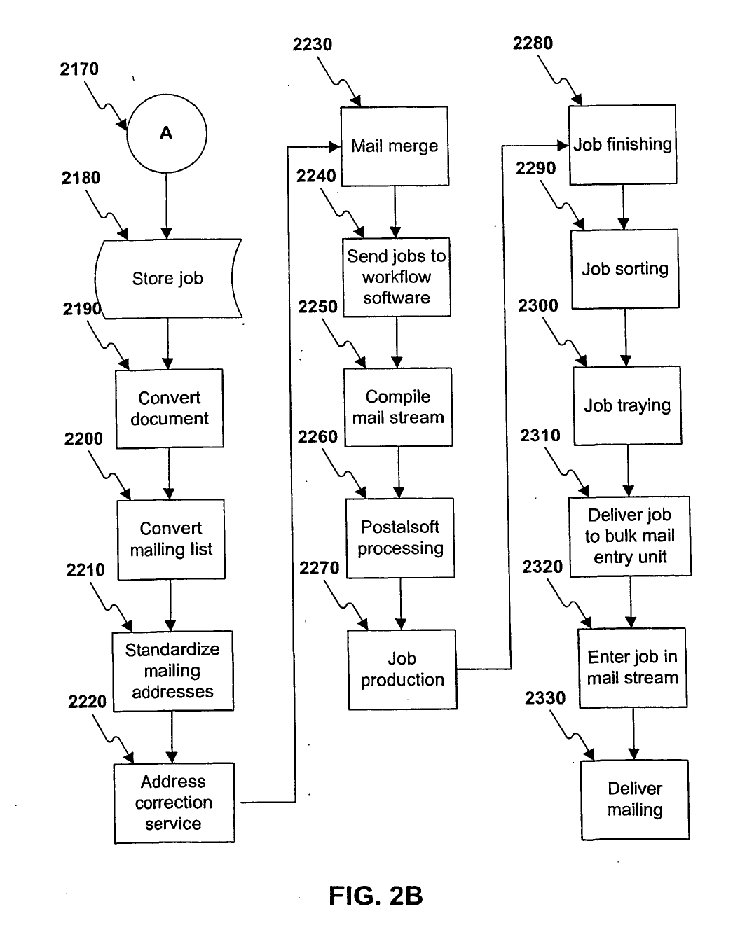

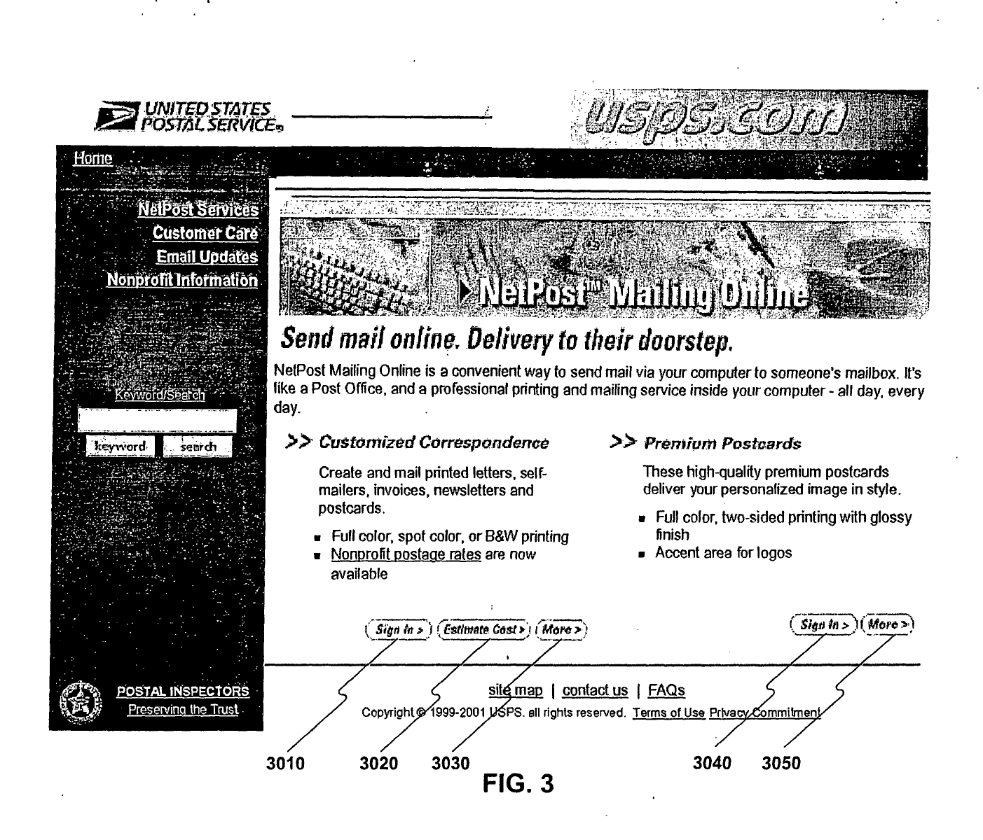

FIG. 2A shows an exemplary flow chart that illustrates a technique for sending the document from the customer to an addressee. First, the customer may communicate with the SP 1030 (FIG. 1) using a browser program on the personal computer 1010 to access the SP 1030 through the network 1020. For example, the customer may use the NAVIGATOR™ program developed by NETSCAPE™, or the INTERNET EXPLORER™ program developed by MICROSOFT™ to access a graphical user interface, such as the one shown in FIG. 3, provided by the SP 1030.

Referring back to FIG. 2A, after the customer is authenticated by the SP 1030, the customer may provide an electronic version of a document to the SP 1030 (stage 2030). The customer may either create a document on-line, such as by typing information into a text box provided by the SP 1030, or the customer may upload the document in a recognized format. For example, the customer may upload the document in the format recognized by word processing software such as MS WORD™ or WORDPERFECT™; or by desktop publishing software such as PAGEMAKER™, VENTURA™ or QUARK™. Alternatively, the document may be uploaded in a platform-independent format, such as PostScript™ or the Portable Document Format (PDF) developed by ADOBE™. Systems consistent with the present invention may include new document formats as desired.

Next, the SP 1030 may store the electronic version of the document to facilitate additional processing (stage 2040). For example, the SP 1030 may store the provided document for a period of time, such as 60 days. The customer may also manage documents stored by the SP 1030. For example, the customer may selectively delete documents stored by the SP 1030. Then the SP 1030 may determine the file types of the document and the mailing list (stage 2042). If the document has characteristics that may be harmful to the mailing online system, then the document may be filtered out. For example, the SP 1030 may reject the document and advise the customer if the document incorporates unsupported features of an otherwise recognized document format. The SP 1030 may also examine the document to determine whether it should be merged with information from the mailing list, as a mail merge file. After the file type is determined, the SP 1030 may examine the file for viruses (stage 2044). For example, the SP 1030 may examine the file to determine if the document contains a MS-WORD™ macro virus. The SP 1030 may reject the document and advise the customer if the SP 1030 determines that the document contains a virus.

Next, the document file may be converted into an intermediate format, such as PDF (stage 2046). For example, a WORDPERFECT™ document file may be converted into a PDF document for better compatibility. After the document is converted, the customer may validate the document (stage 2050). For example, the customer may proof the converted document using the browser on the personal computer to view the converted document and verify that the document was converted properly. If the document is not valid (stage 2060), then the customer may upload another document (stage 2030).

The customer may then provide an address list to the SP 1030 (stage 2070). The customer may either create an address list, such as by typing information into a provided text box, or may upload the mailing list in a recognized format. Thus, the customer may assemble the mailing list by downloading the addresses and data from existing commercial databases, then upload the mailing list to the SP 1030. For example, the customer may upload the mailing list in MS EXCEL™, MS ACCESS™, MS WORD™ table, or ASCII delimited text format. Systems consistent with the present invention may include additional mailing list formats as desired.

Next, the SP 1030 may store the mailing list locally to facilitate additional processing (stage 2080). For example, the SP 1030 may store the mailing list for a predetermined period of time, such as 60 days. After the mailing list is stored, the SP 1030 may validate that the mailing list conforms to the specified predetermined format (stage 2090). For example, the SP 1030 may verify that an address list designated as a MS EXCEL™ document actually conforms to the MS EXCEL™ specification. If the mailing list is not valid (stage 2100), then the customer may upload another mailing list (stage 2070).

The SP 1030 may also validate each physical delivery address in the list. For example, the SP 1030 may verify that a street address is within a valid range of addresses and that a ZIP code corresponds to a designated city and generate a report identifying addresses that cannot be matched with a database. For example, the SP 1030 may attempt to match addresses with the USPS™ Address Management System database. The customer may either purge the identified addresses from the list, or may send the document to the identified addresses at a non-discounted service rate.

Then the SP 1030 may estimate a fee for sending each document to each address in the mailing list. For example, the SP 1030 may estimate a fee for delivery of each document based on whether the document will be sent at a First-Class service rate, a Standard service rate, or a Non-Profit service rate. The SP 1030 may also consider other factors when estimating the fee for delivery of each document. For example, the SP 1030 may consider location of the printing site 1040 relative to each address in the mailing list, the depth of sorting possible for the documents to be delivered, and whether the type of document to be sent, such as a postcard, may qualify for a reduced service rate. If the customer accepts the mailing list, the document is submitted for mailing (stage 2110). The customer may select from predetermined printing and finishing specifications, select a desired service class, and select the type of documents being sent.

The SP 1030 may also estimate a fee for printing each document. For example, the SP 1030 may select a printing site 1040 from one or more printing sites, based on proximity to the delivery address of the document; production capacity of the printing site for the type of document selected by the customer, such as a booklet; whether the printing site 1040 is presently operational; and a fee for printing the type of document selected by the customer at the printing site 1040. Printing fees may also vary according to the number of printing colors selected by the customer. For example, a fee for printing a document in black & white may be less than a fee for printing the document in color, and a fee for printing the document with a limited number of colors, such as a highlight color, may be less than a fee for full color printing, such as for a photo-realistic image. The printing fee may also vary according to the type of paper selected by the customer. For example, the customer may select off-white 28# paper, white 24# paper, yellow 24# paper, or white 80# postcard stock. The printing fee may further vary according to the paper size. For example, the customer may select to print the document on 8.5 inch by 11 inch paper, 8.5 inch by 14 inch paper, 11 inch by 17 inch paper, A4 size paper, or A5 size paper. The SP 1030 may then estimate fees for printing and delivery of the documents to the customer.

For example, the mailing list may include both domestic addresses within the United States and international addresses. The SP 1030 may determine which printing sites can produce the type of document selected by the customer based on printing and finishing services offered at each printing site and the printing site's capacity to produce documents of the selected type. The SP 1030 may then estimate fees for printing the document at each available site, and estimate fees for sending each document from each site to the corresponding delivery address. The SP 1030 may combine the fees for printing and sending each document to provide the customer with a report detailing the shipping cost, printing, and production fees. Then the customer may approve the transaction and provide payment information, such as a credit card number, prepaid account, or other approved payment method (stage 2120). The SP 1030 may confirm the payment by validating the payment information (stage 2130), such as by billing the credit card for the specified fees. If the payment is not confirmed (stage 2140), then the customer may provide alternative payment information (stage 2120). The mailing online process flow of FIG. 2A is continued in FIG. 2B (stage 2170). After the payment is confirmed, the job may be stored for processing (stage 2180). The document may be converted into another intermediate format to facilitate merging the document with the mailing list (stage 2190). Similarly, the mailing list may be converted into an intermediate format to facilitate merging the mailing list with the document (stage 2200). For example, a MS-ACCESS™ mailing list may be converted into an ASCII delimited text file for improved compatibility.

After the mailing list is converted, the delivery addresses may be standardized (stage 2210). For example, a “standardized” address may conform to an address format specified in USPS Publication 40, Address Information Systems: Products and Services,(PUB 40), which is incorporated herein by reference in its entirety. PUB 40 defines a standardized address as having certain characteristics, such as, the bottom line should include only the city name, state, and correct ZIP CODE™ or ZIP+4 code for the delivery address; the next line up from the bottom should include the delivery address; and the next line up from the bottom should identify the intended recipient. Additional “standardized” address are specified in USPS Publication 28, Postal Addressing Standards (PUB 28), which is incorporated herein by reference in its entirety. PUB 28 provides specifications for physical delivery addressing standards and business addressing standards including, for example, guidelines for address formatting, two-letter state and possession abbreviations, street abbreviations, unusual addressing situations, alphanumeric and/or fractional coding. PUB 28 also provides abbreviations for county, state, and local highways; business words; and Spanish-language addresses;

Standardizing a delivery address may convert an incomplete delivery address into a complete delivery address. For example, if the street name in the delivery address is spelled incorrectly, the street name may be corrected. For another example, if the street name is missing a directional signal, such as “N” for north, “S” for south, “E” for east, or “W” for west, then the missing directional signal may be added. For yet another example, if part of the street name is missing, such as “road,” “street,” “avenue,” or “boulevard,” then the missing information may be added. Thus, an incomplete address may be converted into a correct and complete delivery address before the document is sent.

After the addresses are standardized, each address may be updated by an address correction service (stage 2220). For example, addresses may be updated by verifying each address in the mailing list using the USPS's FASTFORWARD™ service, which includes a National Change of Address database. If an addressee has moved, then the address in the mailing list may be replaced with the addressee's new address.

Next, the document may be merged with information from the mailing list (stage 2230). For example, the MS-WORD™-mail merge tool or the WORDPERFECT™ mail merge tool may be used to merge the document with each record in the mailing list. The mailing list may include one or more delivery addresses, as well as additional information for customizing each document. For example, the customer may send itemized invoices to each address in the mailing list. The additional information may include a description of services for each recipient, a fee associated with the services, and an account balance. The mail merge tool may merge the additional information may be merged into the document to customize each mail piece for the intended recipient. The additional information may also include job data, such as printing and finishing instructions. The customer may also indicate that an enclosure, such as, for example, a reply envelope or a personalized coupon, should be sent to some delivery addresses.

Then the merged documents and job data may be organized for routing to one or more printing sites, such as, for example, by using workflow software (stage 2240). The “jobs”, comprising the merged document and job data, may be compiled into a mailstream and transmitted to the one or more printing sites (stage 2250). For example, a job may be transmitted to a first printing site 1040. If the first printing site 1040 becomes unable to process the job, for example, due to equipment failure, then the first printing site 1040 may inform the SP 1030 and the SP 1030 may transmit the job to a second printing site (not shown). Otherwise, the first printing site 1040 may process the job and indicate to the SP 1030 that the job has been printed. The SP 1030 may wait for a predetermined period of time, for example, 24 hours, to receive the indication from the first printing site 1040 that the job has been printed. If the SP 1030 does not receive the indication from the first printing site 1040 within the predetermined period of time, then the SP 1030 may transmit the job to the second printing site to be printed. Thus, if the SP 1030 becomes unable to communicate with the first printing site 1040, then the job may be printed by the second printing site.

At each printing site, each “job” may be pre-sorted before printing to facilitate delivery of the mail pieces according to mail carrier routes (stage 2260). For example, POSTALSOFT™ software, manufactured by Addressing Systems and Products, Inc., may sort each job by ZIP+4 code before printing. Then the jobs may be printed (stage 2270) to produce mail pieces, and each mail piece may be finished (stage 2280). For example, each merged document may be stapled, folded, and inserted in an envelope, according to the customers selections. The finished mail pieces may be sorted (stage 2290), placed in trays (stage 2300), and delivered to a bulk mail entry unit (BMEU) (stage 2310). For example, the mail pieces may be organized into ascending numeric sequential order, marked with a unique identifier on each piece, such as a delivery bar code, placed into a postal tray, and transported to a specialized facility for accepting mail pieces that are presorted according to standards specified in the USPS Domestic Mail Manual. Then each mail piece may be distributed for letter carrier delivery (stage 2320) and delivered to the addressee (stage 2330).

FIG. 3 is an exemplary graphical user interface, such as a web page, for a mailing online service in accordance with methods and systems consistent with the present invention. The customer may select from various options to generate one or more of a plurality of document types, such as, for example customized correspondence or premium postcards. For example, the customer may select a first “Sign In” button 3010 to access the customized correspondence service, an “Estimate Cost” button 3020 to receive an estimated cost for preparing the customized correspondence, or a first “More” button 3030 to request additional information about the customized correspondence service. For another example, the customer may select a second “Sign In” button 3040 to access the premium postcards service or a second “More” button 3050 to request additional information about the premium postcards service.

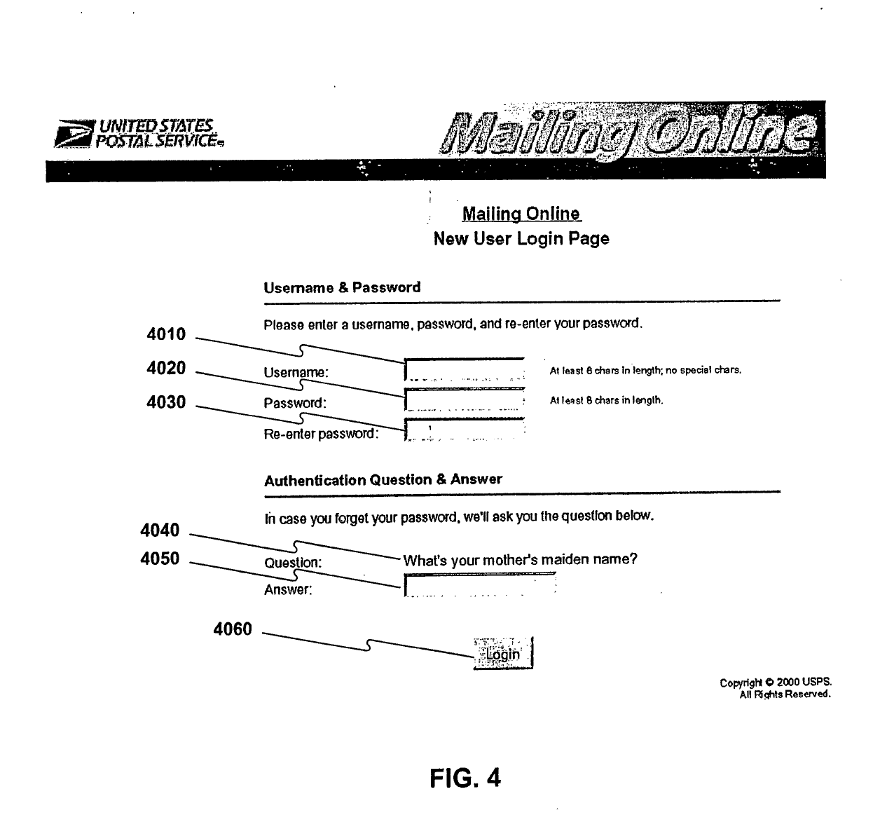

Next, the customer may register with the SP 1030 to establish a customer profile (stage 2010). FIG. 4 is an exemplary graphical user interface, such as a web page, for registering the customer in accordance with methods and systems consistent with the present invention. The customer may use a “Username”control 4010 to provide a unique identifier. The customer may use a “Password” control 4020 to authenticate the customer. For security reasons, the graphical user interface may display asterisks instead of the password 4020, so that the password 4020 is not visible. Therefore, the customer may use a “Re-enter password” control 4030 to confirm the password 4020. The customer may use an “Answer” control 4050 to provide an answer to a predetermined question 4040 in case the customer forgets his password. Finally, the customer may select a “Login” button 4060 to submit the provided information to the SP 1030 and access the mailing services (stage 2020).

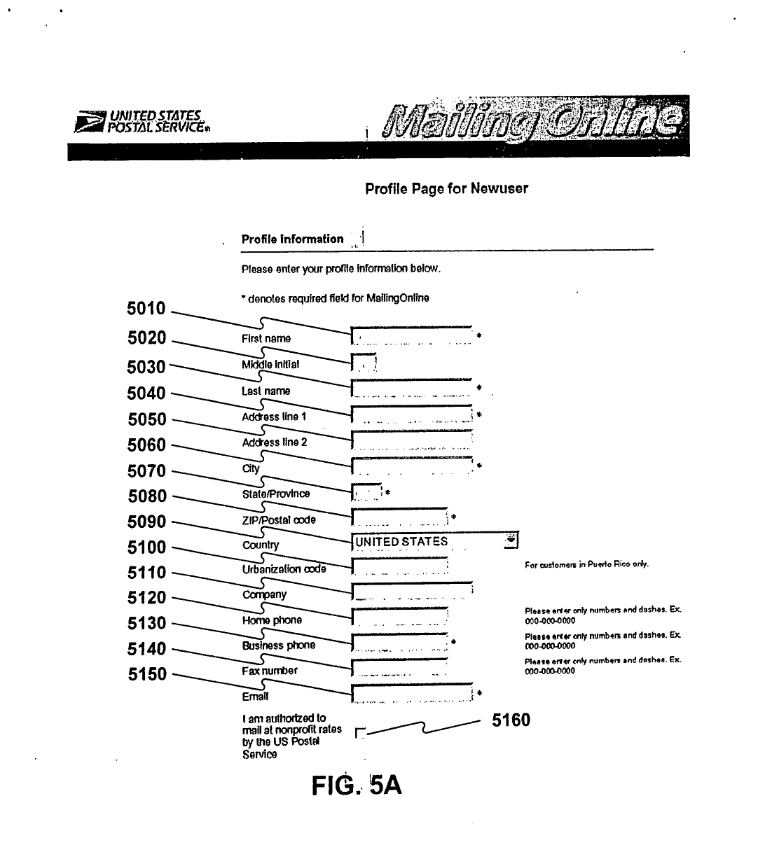

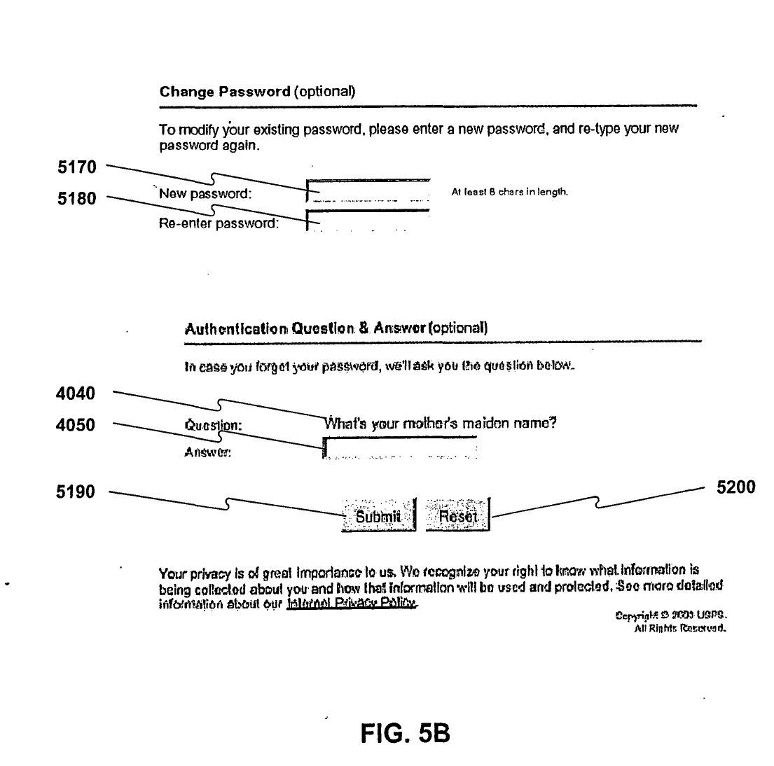

The SP 1030 may require that the customer provide additional information before permitting access to the mailing services. FIGS. 5A and 5B show an exemplary graphical user interface, such as a web page, for profiling the customer in accordance with methods and systems consistent with the present invention. For example, the SP 1030 may require that the customer provide a first name 5010, a last name 5030, a postal address 5040, a city 5060, a state 5070, a ZIP and/or postal code 5080, a business telephone number 5130 and an e-mail address 5150. The SP 1030 may also request that the customer enter additional information, such as a middle initial 5020, additional address information 5050, a country 5090, an urbanization code 5100 for addresses in Puerto Rico, a company name 5110, a home telephone number 5120, a fax number 5140, and an indication whether the customer is authorized to mail at nonprofit rates 5160. Additionally, the customer may change his password 4020 by entering a new password in a “New password” text box 5170 and re-entering the new password in a “Re-enter password” text box 5180. The customer may also revise his answer 4050 to the predetermined question 4040. Finally, the customer may select a “Submit” button 5190 to submit the provided information to the SP 1030, or a “Reset” button 5200 to cancel any changes made.

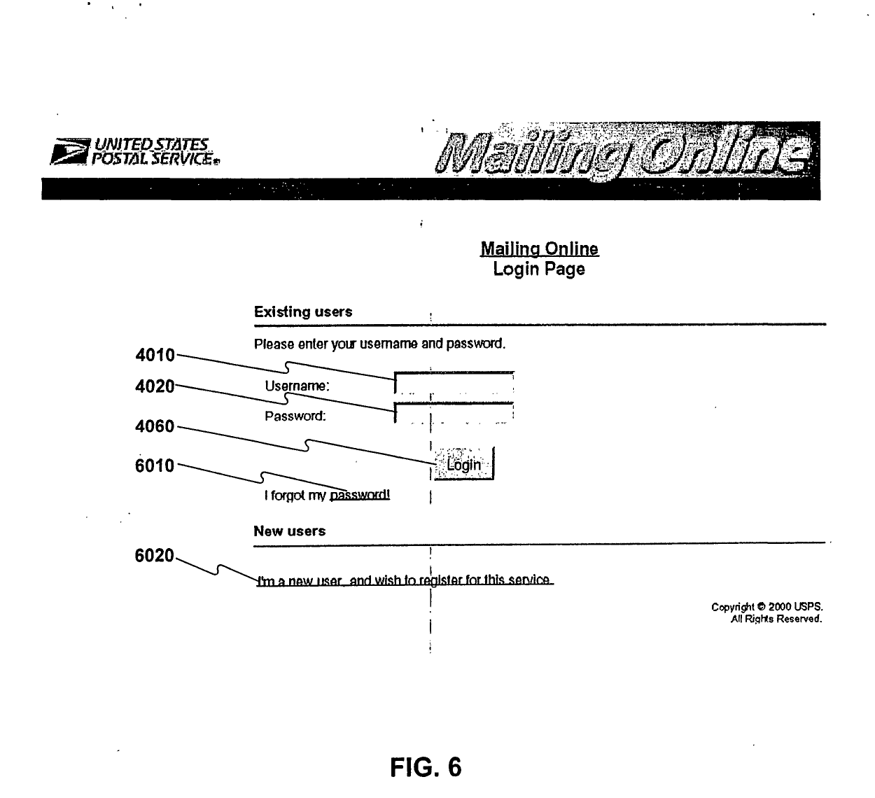

After the customer profile is established, the SP 1030 may present a simplified graphical user interface. FIG. 6 is an exemplary graphical user interface, such as a web page, for accessing the mailing online service in accordance with methods and systems consistent with the present invention. The customer may request that the SP 1030 authenticate them by providing his username 4010 and password 4020, and then selecting the “Login” button 4060 to access the mailing services (stage 2020). If the customer forgets his password 4020, then he may select a hyperlink 6010 to request that the SP 1030 send his password 4020 to the provided e-mail address 5150. Otherwise, the customer may select another hyperlink 6020 to register as a new customer.

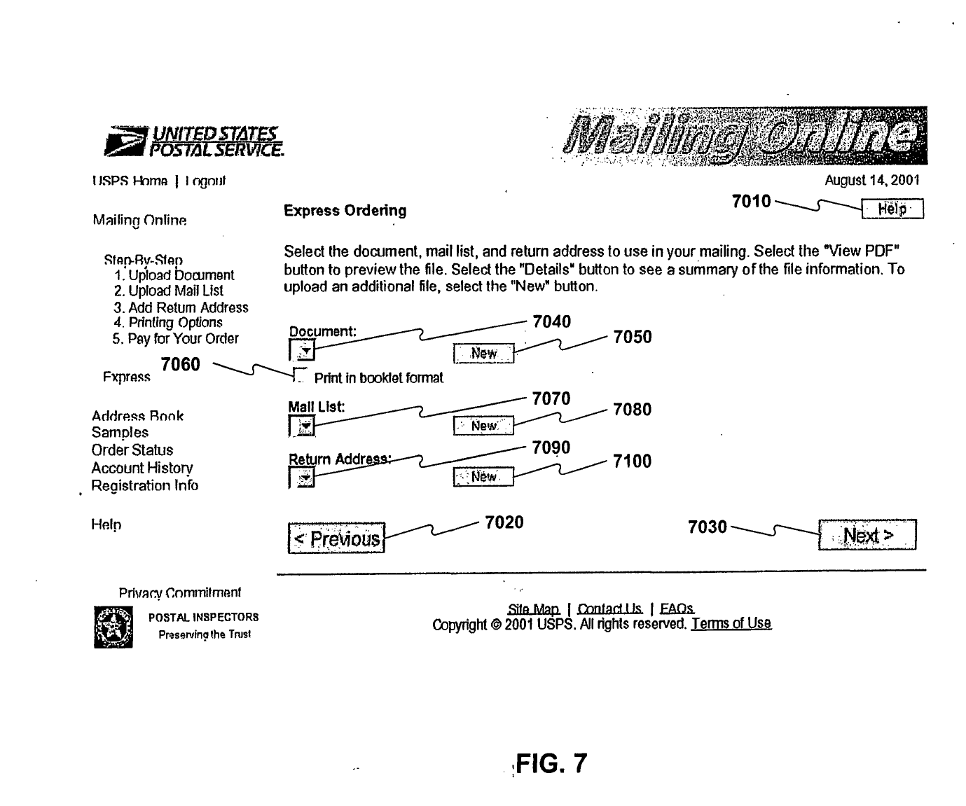

After the customer accesses the mailing services (stage 2020) the customer may order mailing online service from the SP 1030. FIG. 7 is an exemplary graphical user interface, such as a web page, for express ordering a mailing online service in accordance with methods and systems consistent with the present invention. If the customer previously provided the document to the SP 1030, then the customer may select the document from a “Document” list 7040. Otherwise, the customer may provide a new document to the SP 1030 by selecting a first “New” button 7050. The customer may create the new document on-line, such as by typing in a text box (not shown) provided by the SP 1030, or the customer may use the processor 1010 to transmit the new document to the SP 1030 (stage 2030). After the customer provides the new document to the SP 1030, the SP 1030 may store the new document (stage 2040) for additional processing. For example, the SP 1030 may validate the new document to ensure that it conforms to a recognized format, such as an MS WORD™ document (stage 2050). If the SP 1030 determines that the new document conforms to a recognized format (stage 2060), then the document list 7040 may be updated to include the new document. Then the customer may select the new document from the document list 7040.

If the customer previously provided the mailing list to the SP 1030, then the customer may select the mailing list from a “Mail List” control 7070. Otherwise, the customer may provide a new mailing list to the SP 1030 by selecting a second “New” button 7080. The customer may create the new mailing list on-line, such as by typing in a text box (not shown) provided by the SP 1030, or the customer may use the processor 1010 to transmit the new mailing list to the SP-1030 (stage 2070). After the customer provides the new mailing list to the SP 1030, the SP 1030 may store the new mailing list (stage 2080) for additional processing. For example, the SP 1030 may validate the new mailing list to ensure that it conforms to a recognized format, such as an MS EXCEL™ document (stage 2090). If the SP 1030 determines that the new mailing list conforms to a recognized format (stage 2100), then the “Mail List” control 7070 may be updated to include the new mailing list. Then the customer may select the new mailing list with the “Mail List” control 7070.

If the customer previously provided a return address to the SP 1030, then the customer may select the return address from a “Return Address” control 7090. Otherwise, the customer may provide a new return address to the SP 1030 by selecting a third “New” button 7100. The customer may provide the new return address on-line, such as by typing in a text box (not shown) provided by the SP 1030, or the customer may use the processor 1010 to transmit a list of return addresses in a recognized mailing list format to the SP 1030. For example, the customer may create a mailing list of return addresses in MS EXCEL™ and then upload the mailing list to the SP 1030. Then the customer may select the new return address with the “Return Address” control 7090.

The customer may select various printing options for the document. For example, the customer may indicate whether to print the selected document in booklet format 7060. The customer may select a Previous button 7020 to exit from the web page without ordering the mailing service, or the user may select a Next button 7030 to submit the mailing (stage 2110). The customer may also select a help button 7010 to request additional help.

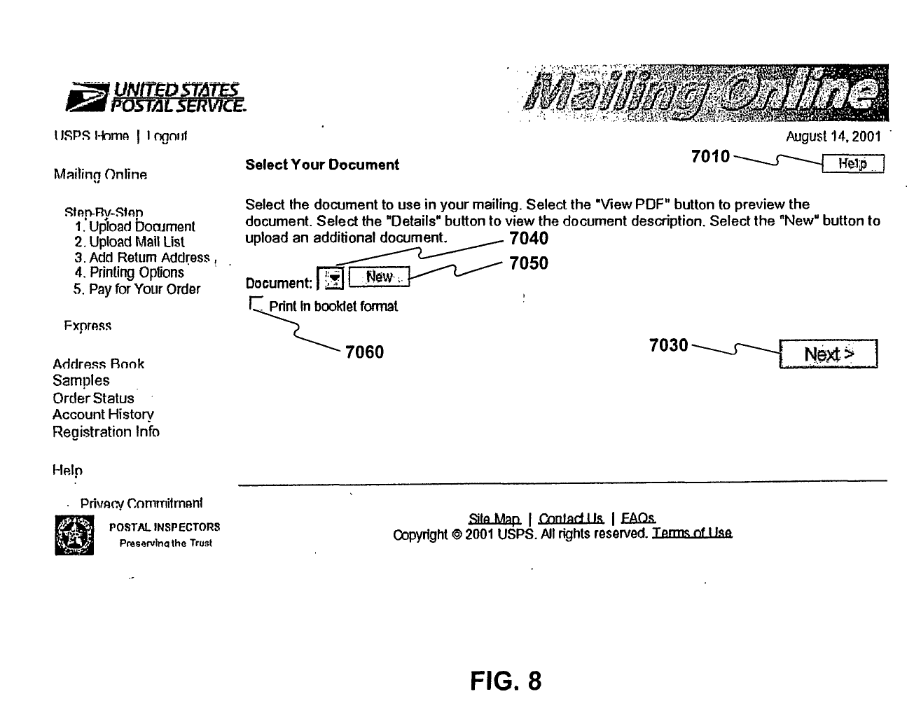

Alternatively, the SP 1030 may lead the customer through the process of ordering on-line mailing services in a step-by-step manner. FIG. 8 is an exemplary graphical user interface, such as a web page, for selecting the document to be sent in accordance with methods and systems consistent with the present invention. After the customer selects a document, he may select a mailing list 7070, provide a return address 7090, and select various printing options for the document using subsequent web pages (not shown).

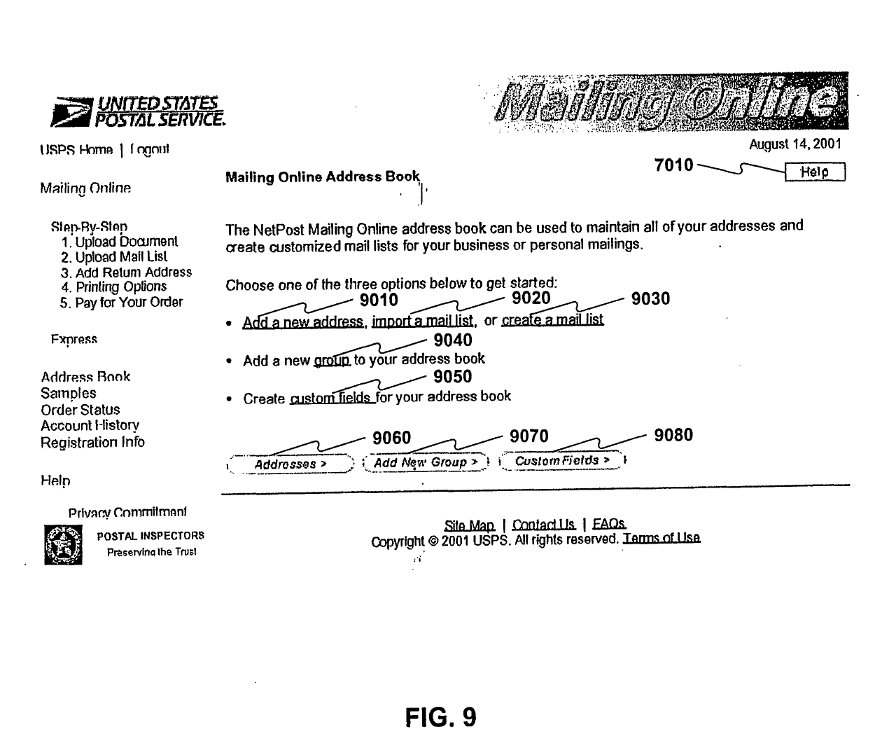

The customer may organize his mailing lists using an online address book. FIG. 9 is an exemplary graphical user interface, such as a web page, for maintaining one or more mailing lists in accordance with methods and systems consistent with the present invention. The customer may select a first hyperlink 9010 to add a new address to an address list, a second hyperlink 9020 to upload an address list in a recognized format, or a third hyperlink 9030 to create a new mailing list. The customer may organize addresses into groups. For example, the customer may indicate whether the addresses relate to personal or business relations. The customer may also select a fourth hyperlink 9040 or an “Add New Group” button 9070 to create a new address group. The customer may select an Addresses button 9060 to review the available addresses. The customer may select a “Custom Fields” button 9080 to define additional address information fields. The customer may also select a help button 7010 to request additional help.

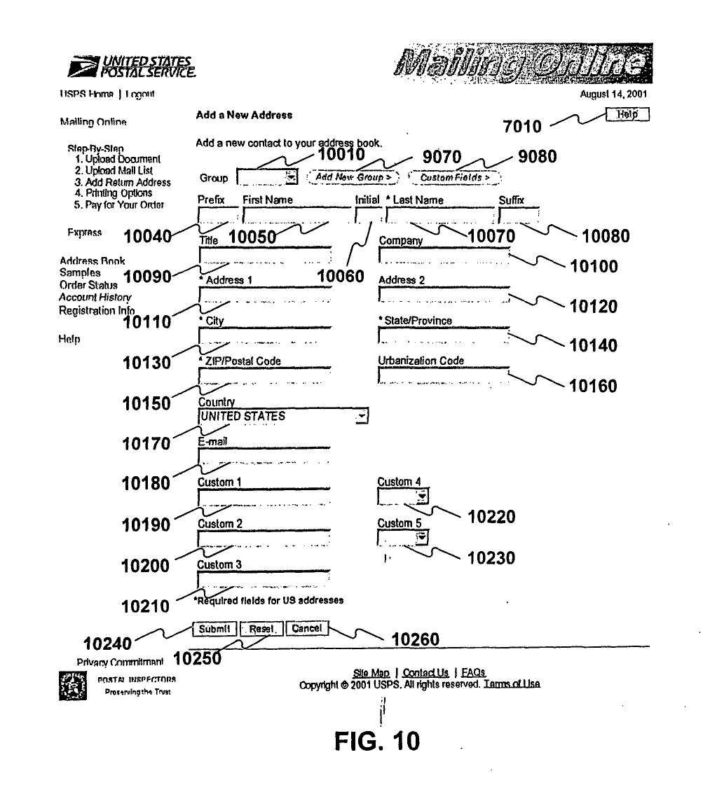

The customer may add new addresses to the address book maintained by the SP 1030. FIG. 10 is an exemplary graphical user interface, such as a web page, for adding a new address to the address book in accordance with methods and systems consistent with the present invention. The customer may select a group for the new address from a Group list 10010. The customer may indicate a prefix 10040, first name 10050, middle initial 10060, last name 10070, suffix 10080, title 10090, and e-mail address 10180 for a person at the mailing address. The customer may also indicate the company name 10100, first address line 10110, second address line 10120, city 10130, state 10140, ZIP/Postal code 10150, urbanization code 10160 for addresses in Puerto Rico, and country 10170 of the mailing address. The SP 1030 may require that the customer indicate certain information to qualify for reduced postal service rates, such as the first address line 10110, city 10130, state 10140, and ZIP/Postal code 10150 for the person at the mailing address. The customer may provide additional information using customer-defined fields 10190-10230. The customer may also select an “Add New Group” button 9070 to create a new address group, a “Custom Fields” button 9080 to define additional address information fields, or a Help button 7010 to request additional help. After the customer finishes entering information, he may select a Submit button 10240 to save the new address, a Reset button 10250 to clear any selections made, or a cancel button 10260 to return to the previous web page (FIG. 9).

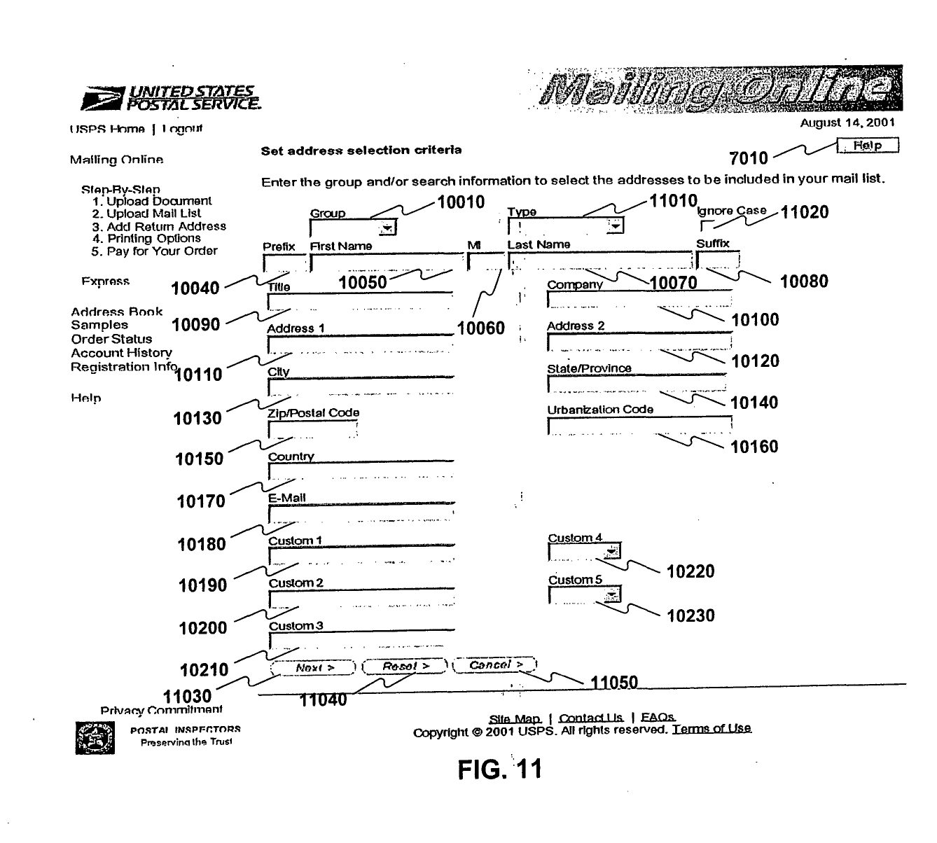

The customer may make an address list by selecting one or more addresses from the address book. FIG. 11 is an exemplary graphical user interface, such as a web page, for selecting one or more addresses from the online address book in accordance with methods and systems consistent with the present invention. The customer may select addresses using criteria such as the prefix 10040, first name 10050, middle initial 10060, last name 10070, suffix 10080, title 10090, and email address 10180 for the person at the mailing address. The customer may also select addresses using criteria such as the company name 10100, first address line 10110, second address line 10120, city 10130, state 10140, ZIP/Postal code 10150, urbanization code 10160 for addresses in Puerto Rico, country 10170, and contents of the customer-defined fields 10190-10230. The customer may further select addresses according to address type 11010. For example, the customer may restrict selection to “standard” addresses that conform to requirements for reduced postal service fees, or non-standard physical delivery address that require First-Class service fees. The customer may indicate whether to ignore character case in the fields (10040-10230) when selecting addresses using an “Ignore Case” check box 11020. The customer may also select a Help button 7010 to request additional help. After the customer finishes entering selection criteria, he may select a Next button 11030 to create an address list from any addresses conforming to the selection criteria, a Reset button 11040 to clear any selections made, or a cancel button 11050 to return to the previous web page (FIG. 9).

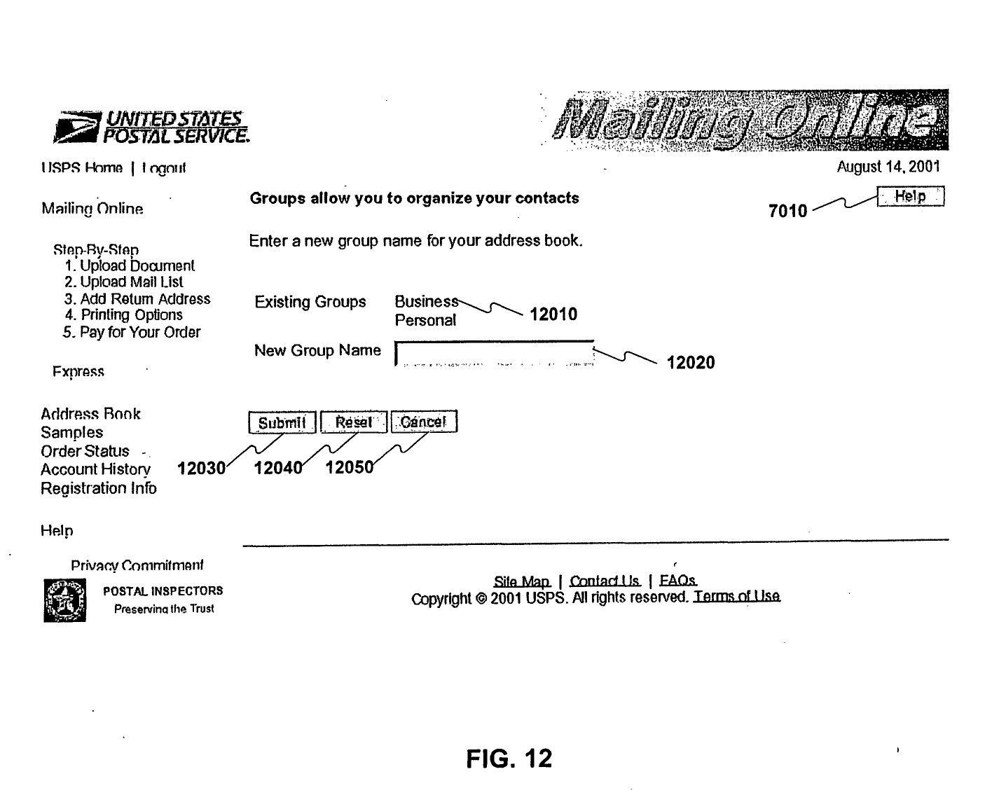

The customer may add new groups to facilitate organizing his addresses. FIG. 12 is an exemplary graphical user interface, such as a web page, for adding a new address group in accordance with methods and systems consistent with the present invention. The customer may review a list 12010 of existing address groups displayed on the web page. The customer may also add a new address group by entering the name of the new address group in a “New Group Name” text box 12020 and selecting a Submit button 12030. The customer may select a Help button 7010 to request additional help, a Reset button 12040 to clear any text entered, or a Cancel button 12050 to return to the previous web page (FIG. 9).

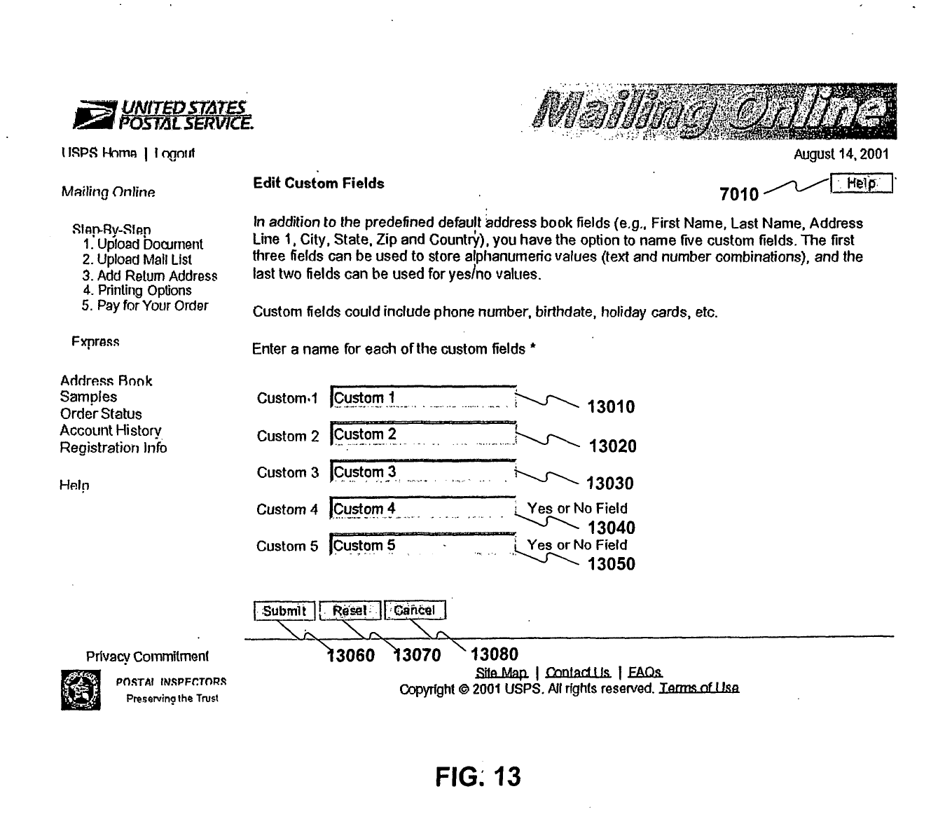

In addition to predefined address fields, the customer may add custom data fields for the address book. For example, the customer may add custom data fields to store phone numbers, birth dates, or holiday cards. FIG. 13 is an exemplary graphical user interface, such as a web page, for customizing an address field in accordance with methods and systems consistent with the present invention. The customer may enter a name for each custom data field with a corresponding text box 13010-13050. The customer may also select a Help button 7010 to request additional help. After the customer finishes naming the custom data fields, he may select a Submit button 13060 to accept any changes made, a Reset button 13070 to clear any changes made, or a cancel button 13080 to return to the previous web page (FIG. 9).

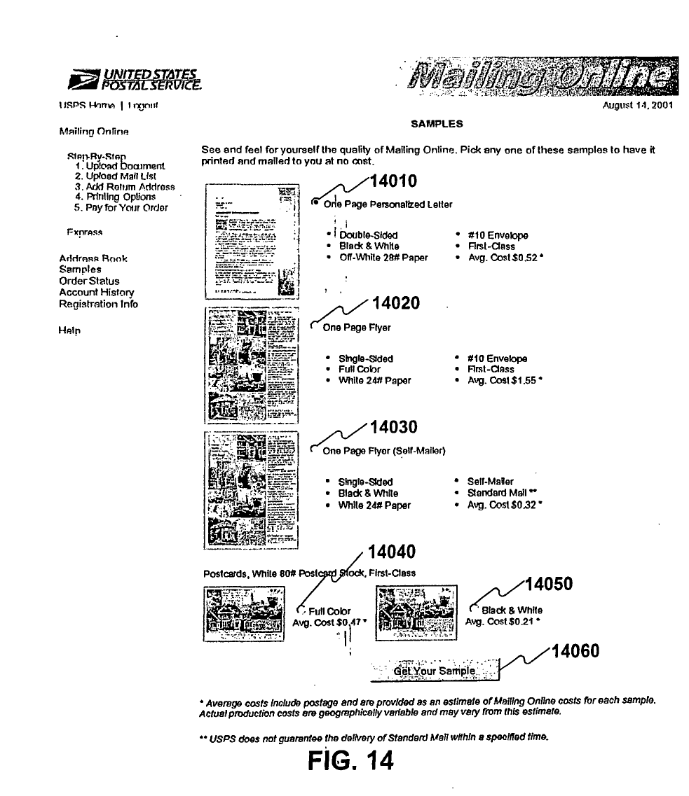

The customer may request to have a sample document sent to them to evaluate a representative document. FIG. 14 is an exemplary graphical user interface, such as a web page, for requesting a sample document in accordance with methods and systems consistent with the present invention. The customer may select various options for printing and finishing a document according to his preferences. For a first example 14010, the customer may select a double-sided one page personalized letter, printed in black & white on off-white 28# paper, and sent in a #10 envelope with First-Class service. For a second example 14020, the customer may select a single-sided one page flyer, printed in full color on white 24# paper, and sent in a #10 envelope with First-Class service. For a third example 14030, the customer may select a single-sided one page flyer, printed in black & white on white 24# paper, and sent as a self-mailer with standard service. For a fourth example 14040, the customer may select a postcard, printed in full color on white 80# postcard stock, and sent with First-Class service. For a fifth example 14050, the customer may select a postcard, printed in black & white on white 80# postcard stock, and sent with First-Class postage. Each example (14010-14050) may include the estimated cost per mail piece. The customer may select a “Get Your Sample” button 14060 to submit his request for the selected example document.

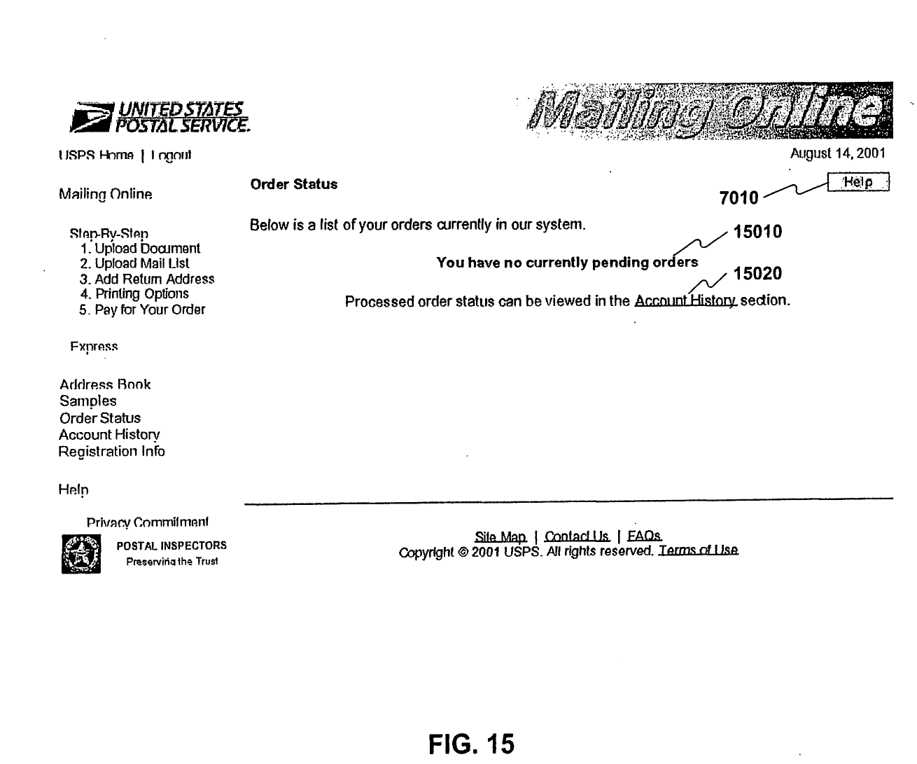

After a mailing order is submitted (stage 2150 of FIG. 2), the customer may monitor the status of the order. FIG. 15 is an exemplary graphical user interface, such as a web page, for monitoring status of a pending service order in accordance with methods and systems consistent with the present invention. The customer may view a list of any pending orders; otherwise, a message 15010 may indicate that no orders are pending. The customer may select a hyperlink 15020 to view a list of any completed orders. The customer may also select a Help button 7010 to request additional help.

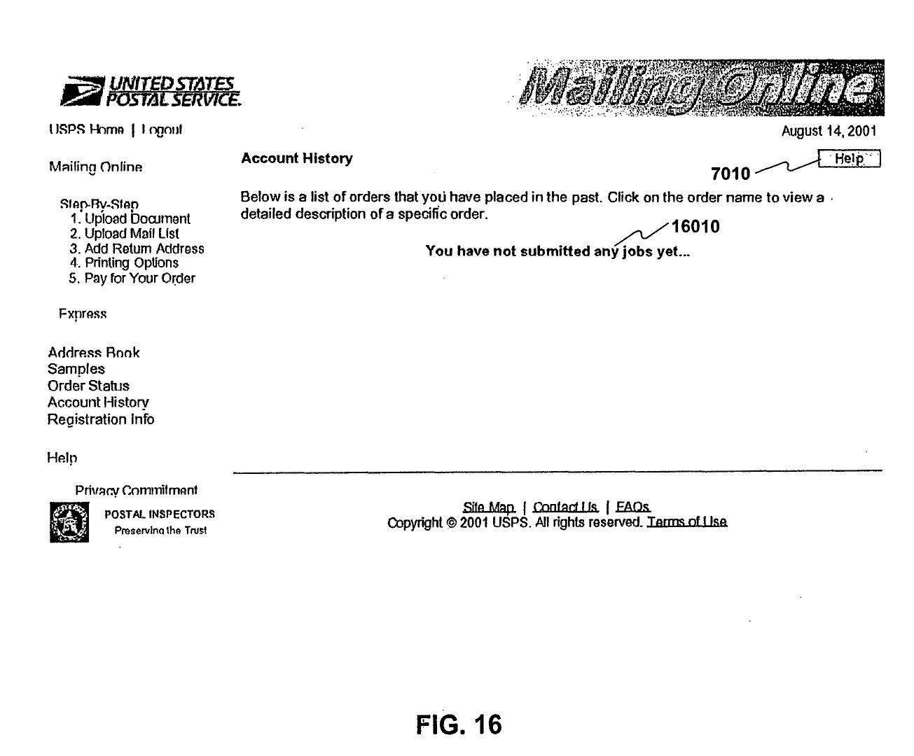

After production of a mailing order is completed (stage 2270 of FIG. 2), the customer may review the order. FIG. 16 is an exemplary graphical user interface, such as a web page, for reviewing one or more completed service orders in accordance with methods and systems consistent with the present invention. The customer may view a list of any completed orders; otherwise, a message 16010 may indicate that no orders have been completed. The customer may also select a Help button 7010 to request additional help.

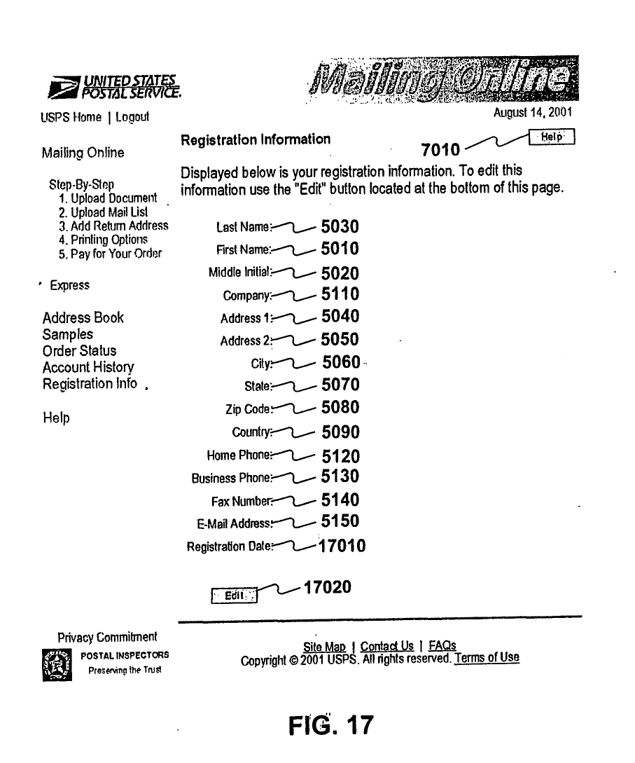

The customer may review and update his registration information as desired. FIG. 17 is an exemplary graphical user interface, such as a web page, for updating customer registration information in accordance with methods and systems consistent with the present invention. The customer may review his registration information including his last name 5030, first name 5010, middle initial 5020, company name 5110, first address line 5040, second address line 5050, city 5060, state 5070, ZIP code 5080, country 5090, home telephone number 5120, business telephone number 5130, fax number 5140, e-mail address 5150, and a date when the customer registered 17010. The customer may revise and update his displayed information by selecting an Edit button 17020. The customer may also select a Help button 7010 to request additional help.

The above embodiments and other aspects and principles of the present invention may be implemented in various environments. Such environments and related applications may be specially constructed for performing the various processes and operations of the invention, or he may include a general-purpose computer or computing platform selectively activated or reconfigured by program code (also referred to as code) to provide the necessary functionality. The processes described herein are not inherently related to any particular computer or other apparatus, and may be implemented by a suitable combination of hardware, software, and/or firmware. For example, various general-purpose machines may be used with programs written in accordance with teachings of the present invention, or it may be more convenient to construct a specialized apparatus or system to perform the required methods.

The present invention also relates to computer readable media that include program instructions or program code for performing various computer-implemented operations based on the methods and processes of the invention. The media and program instructions may be those specially designed and constructed for the purpose of the invention, or he may be of the kind well-known and available to those having skill in the computer software arts. Examples of program instructions include micro-code, machine code, such as produced by a compiler, and files containing high-level code that can be executed by the computer using an interpreter.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for delivery of a printed document using at least one processor interfacing a network, the method comprising:
receiving first information, through the network and at the at least one processor, specifying an electronic version of a document;
providing second information, from the at least one processor and through the network, indicating one or more options for printing the document;
selecting a printing option from the one or more options for printing the document;
receiving third information, through the network and at the at least one processor, indicating at least one physical delivery address to which the document will be sent;
processing the electronic version of the document according to the selected printing option to create a print file;
selecting a printing site from one or more printing sites;
transmitting the print file to the selected printing site;
printing the print file at the selected printing site; and
providing the printed document to a service provider for delivery to the physical delivery address.

2. The method of claim 1, wherein the document conforms to a predetermined format recognized by a program selected from a group consisting of MS WORD, COREL WORDPERFECT, ADOBE PAGEMAKER, VENTURA, and QUARK.

3. The method of claim 1, wherein the second information comprises a document type, selected from a group consisting of a booklet, a letter, a flyer, and a postcard.

4. The method of claim 1, wherein the second information comprises a document enclosure, selected from a group consisting of an envelope, a self-mailer, a coupon, and a postcard.

5. The method of claim 1, wherein the second information comprises one or more finishing instructions, selected from a group consisting of folding, binding, stapling, single-sided printing, double-sided printing, full color printing, limited color printing, and black & white printing.

6. The method of claim 1, wherein the second information comprises a service class, selected from a group consisting of First-Class service, Standard service, and Non-Profit service.

7. The method of claim 1, wherein the second information comprises a paper type, selected from a group consisting of off-white 28# paper, white 24# paper, yellow 24# paper, and white 80# postcard stock.

8. The method of claim 1, wherein the second information comprises a paper size, selected from a group consisting of 8.5 inch by 11 inch paper, 8.5 inch by 14 inch paper, 11 inch by 17 inch paper, A4 size paper, and A5 size paper.

9. The method of claim 1, further comprising:
selecting the delivery address based on the third information; and
merging the document with the delivery address.

10. The method of claim 9, wherein the third information further indicates fourth information for customizing the document, and the document is merged with the fourth information to create a customized document.

11. The method of claim 1, further comprising:
selecting the delivery address based on the third information; and
standardizing the delivery address to conform with a predetermined address format.

12. The method of claim 1, further comprising:
selecting the delivery address based on the third information;
verifying the delivery address with a database to determine if an addressee corresponding to the delivery address has changed his physical delivery address; and
updating the delivery address when it is determined that the physical delivery address has changed.

13. The method of claim 1, further comprising:
selecting the printing site by at least one criteria selected from a group consisting of capability to produce documents having the selected printing option, proximity of the printing site to the delivery address, capacity to produce documents having the selected printing option, and a fee for printing documents having the selected printing option.

14. The method of claim 1, further comprising:
estimating a fee for printing the document;
estimating a fee for delivering the printed document to the delivery address; and
accepting payment based on the estimated fee for printing the document and the estimated fee for delivering the printed document.

15. A system for delivery of a printed document, using at least one processor interfacing a network, the system comprising:
means for receiving first information, through the network and at the at least one processor, specifying an electronic version of a document;
means for providing second information, from the at least one processor and through the network, indicating one or more options for printing the document;
means for selecting a printing option from the one or more options for printing the document;
means for receiving third information, through the network and at the at least one processor, indicating at least one physical delivery address to which the document will be sent;
means for processing-the electronic version of the document according to the selected printing option to create a print file;
means for selecting a printing site from one or more printing sites;
means for transmitting the print file to the selected printing site;
means for printing the print file at the selected printing site; and
means for providing the printed document to a service provider for delivery to the physical delivery address.

16. The system of claim 15, wherein the document conforms to a predetermined format recognized by a program selected from a group consisting of MS WORD, COREL WORDPERFECT, ADOBE PAGEMAKER, VENTURA, and QUARK.

17. The system of claim 15, wherein the second information comprises a document type, selected from a group consisting of a booklet, a letter, a flyer, and a postcard.

18. The system of claim 15, wherein the second information comprises a document enclosure, selected from a group consisting of an envelope, a self-mailer, a coupon, and a postcard.

19. The system of claim 15, wherein the second information comprises one or more finishing instructions, selected from a group consisting of folding, binding, stapling, single-sided printing, double-sided printing, full color printing, limited color printing, and black & white printing.

20. The system of claim 15, wherein the second information comprises a service class, selected from a group consisting of First-Class service, Standard service, and Non-Profit service.

21. The system of claim 15, wherein the second information comprises a paper type, selected from a group consisting of off-white 28# paper, white 24# paper, yellow 24# paper, and white 80# Postcard stock.

22. The system of claim 15, wherein the second information comprises a paper size, selected from a group consisting of 8.5 inch by 11 inch paper, 8.5 inch by 14 inch paper, 11 inch by 17 inch paper, A4 size paper, and A5 size paper.

23. The system of claim 15, further comprising:
means for selecting the delivery address based on the third information; and
means for merging the document with the delivery address.

24. The system of claim 23, wherein the third information further indicates fourth information for customizing the document, and the means for merging the document further comprises means for merging the document with the fourth information to create a customized document.

25. The method of claim 15, further comprising:
means for selecting the delivery address based on the third information; and
means for standardizing the delivery address to conform with a predetermined address format.

26. The system of claim 15, further comprising:
means for selecting the delivery address based on the third information;
means for verifying the delivery address with a database to determine if an addressee corresponding to the delivery address has changed his physical delivery address; and
means for updating the delivery address when it is determined that the physical delivery address has changed.

27. The system of claim 15, further comprising:
means for selecting the printing site by at least one criteria selected from a group consisting of capability to produce documents having the selected printing option, proximity of the printing site to the delivery address, capacity to produce documents having the selected printing option, and a fee for printing documents having the selected printing option.

28. The system of claim 15, further comprising:
means for estimating a fee for printing the document;
means for estimating a fee for delivering the printed document to the delivery address; and
means for accepting payment based on the estimated fee for printing the document and the estimated fee for delivering the printed document.

29. A computer program product, comprising a computer readable medium having computer program code embodied in said medium, for delivery of a printed document using at least one processor interfacing a network, wherein the program code comprises:
code for receiving first information, through the network and at the at least one processor, specifying an electronic version of a document;
code for providing second information, from the at least one processor and through the network, indicating one or more options for printing the document;
code for selecting a printing option from the one or more options for printing the document;
code for receiving third information, through the network and at the at least one processor, indicating at least one physical delivery address to which the document will be sent;
code for processing the electronic version of the document according to the selected printing option to create a print file;
code for selecting a printing site from one or more printing sites;
code for transmitting the print file to the selected printing site;
code for printing the print file at the selected printing site; and
code for providing the printed document to a service provider for delivery to a physical delivery address.

30. A method for providing on-line document printing and mailing service comprising:
receiving a recipient address data list for an electronic document;
receiving sender selected document printing and finishing specifications from a predetermined specification list;
processing the electronic version of the document and coordinating the electronically processed version of the document with the recipient address data list to create an electronic print file;
transmitting the electronic print file to a document print site selected on the basis of the recipient mailing address code;
printing the document and a mailing permit therefore; and
transporting the document and mailing permit to a local mail service provider based on the recipient mailing address code, whereby the local mail service provider accepts, processes and delivers the document to the recipient.
